(19) United States
(12) Patent Application Publication
(10) Pub. No.: US 2025/0328057 A1
(43) Pub. Date: Oct. 23, 2025

(54) IMAGE CAPTURING SYSTEM CAPABLE OF SWITCHING DIAPHRAGM CONTROLLING ROLE, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: YUSUKE TAMURA, Tokyo (JP)

(21) Appl. No.: 19/176,940

(22) Filed: Apr. 11, 2025

(30) Foreign Application Priority Data
Apr. 19, 2024 (JP) 2024-068158

(51) Int. Cl. G03B 7/095

(52) U.S. Cl. CPC G03B 7/095

(57) ABSTRACT

An image capturing system including a lens apparatus including a diaphragm, a diaphragm driver, an aperture value setting member to set a first aperture value in accordance with a user operation, and a first controller to control the diaphragm driver, and an image capturing apparatus including a second controller to set a second aperture value based on a photometric value, switch a diaphragm controlling role to the first controller from the second controller after controlling the diaphragm driver to drive the diaphragm to the first aperture value via the first controller, when an image capturing mode is switched to a first mode in which the first controller controls the diaphragm driver so as to drive the diaphragm to the first aperture value from a second mode in which the second controller controls the diaphragm driver via the first controller to drive the diaphragm to the second aperture value.

### BACKGROUND

### Technical Field

The aspect of the embodiments relates to an image capturing system capable of selectively controlling an aperture value of a diaphragm provided in a lens apparatus by each of the lens apparatus and an image capturing apparatus, a control method therefor, and a storage medium storing a control program therefor.

### Description of the Related Art

As an image capturing apparatus that captures an image with an image sensor, an image capturing apparatus having a still image capturing mode in which an object is singly captured and a moving image capturing mode in which the object is captured as a moving image (video) constituted by continuous frame images is widespread. Further, there is known an image capturing system capable of selectively controlling an aperture value of a diaphragm provided in a lens apparatus (interchangeable lens) detachable from the image capturing apparatus between the lens apparatus side and the image capturing apparatus side (for example, see Japanese Patent Laid-Open Publication No. 2021-076807).

In the moving image capturing mode, it is desirable that the diaphragm is immediately driven in conjunction with a change of the aperture value by a user on the lens apparatus side in order to record a process of scene transition. On the other hand, in the still image capturing mode, it is desirable that the lens apparatus drives the diaphragm based on an aperture driving instruction from the image capturing apparatus side.

Here, the user may start recording of a moving image by pressing a moving image recording button in a state where the still image capturing mode is set. In this case, it is necessary to shift from the still image capturing mode to the moving image capturing mode, and at that time, it is necessary to perform communication between the image capturing apparatus and the lens apparatus in order to switch a diaphragm controlling role from the image capturing apparatus to the lens apparatus.

### SUMMARY

Accordingly, an aspect of the embodiments provides an image capturing system including a lens apparatus including a diaphragm, a diaphragm driver to drive the diaphragm, an aperture value setting member configured to set a first aperture value in accordance with a user operation, and a first controller configured to control the diaphragm driver, and an image capturing apparatus including a second controller configured to set a second aperture value based on a photometric value, switch a diaphragm controlling role to the first controller from the second controller after controlling the diaphragm driver so as to drive the diaphragm to the first aperture value via the first controller, when an image capturing mode is switched to a first mode in which the first controller controls the diaphragm driver so as to drive the diaphragm to the first aperture value from a second mode in which the second controller controls the diaphragm driver so as to drive the diaphragm to the second aperture value via the first controller.

Further features of the disclosure will become apparent from the following description of exemplary embodiments with reference to the attached drawings.

### BRIEF DESCRIPTION OF THE DRAWINGS

FIG. 1 is a block diagram schematically illustrating a configuration of an image capturing system according to an embodiment.

FIG. 2 is an external perspective view illustrating a lens unit constituting the image capturing system.

FIG. 3 is a schematic view illustrating a live view operation of the image capturing system.

FIG. 4 is a flowchart illustrating a diaphragm control process executed during the live view operation of the image capturing system.

FIG. 5 is a view illustrating a diaphragm drive speed table in a manual diaphragm mode.

FIG. 6 is flowchart illustrating a diaphragm controlling role determination process in S404 in FIG. 4.

FIG. 7 is a timing chart illustrating a process switching the diaphragm controlling role from a camera controller to a lens controller according to the embodiment.

FIG. 8 is a timing chart illustrating a process switching the diaphragm controlling role from the lens controller to the camera controller according to a reference example.

### DESCRIPTION OF THE EMBODIMENTS

Hereafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

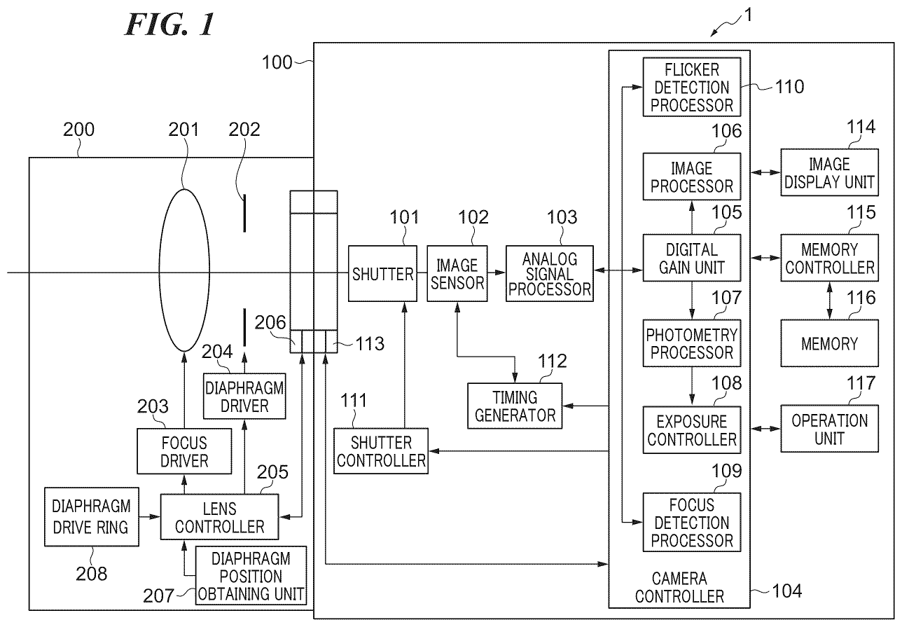

FIG. 1 is a block diagram schematically illustrating a configuration of an image capturing system 1 according to the embodiment. The image capturing system 1 includes an image capturing apparatus 100 (hereinafter, referred to as a “camera 100”) and a lens apparatus 200 (hereinafter, referred to as a “lens unit 200”).

The camera 100 includes a shutter 101, an image sensor 102, an analog signal processor 103, a camera controller (second controller) 104, a shutter controller 111, a timing generator 112, a communication terminal 113, an image display unit 114, a memory controller 115, a memory 116, and an operation unit 117. The lens unit 200 includes a lens system 201, a diaphragm 202, a focus driver 203, a diaphragm driver 204, a lens controller (first controller) 205, a communication terminal 206, and a diaphragm position obtaining unit 207.

First, the configuration of the camera 100 will be described. The camera 100 is assumed to be a mirrorless single-lens camera. In the present embodiment, the shutter 101 is configured as a mechanical shutter that controls an exposure time of a light flux passing through the lens unit 200 to the image sensor 102 by mechanically moving a front curtain and a rear curtain, and is usually in an open state. The driving of the shutter 101 is controlled by the camera controller 104 via the shutter controller 111.

The image sensor 102 is a CMOS sensor or a CCD sensor, for example. The object light flux incident on the lens unit 200 forms an image on an image capturing surface of the image sensor 102, and the image sensor 102 converts the optical image of the object into an analog electric signal by photoelectric conversion and outputs the analog electric signal to the analog signal processor 103. The image sensor 102 includes a plurality of focus detection pixels that photoelectrically convert an image formed by a light flux divided from the light flux from the lens unit 200 in addition to image capturing pixels.

The timing generator 112 generates a signal for controlling the timing of reset or signal readout in the image sensor 102 under the control of the camera controller 104, and supplies the signal to the image sensor 102. The timing generator 112 sets an incident time of the object light flux on the image sensor 102, that is, implements what is called an electronic shutter function. The analog signal processor 103 converts the analog electric signal transmitted from the image sensor 102 into a digital signal (an image signal) by A/D conversion, and outputs the digital signal to the camera controller 104. The analog signal processor 103 may be incorporated in the image sensor 102.

The camera controller 104 is a microcomputer including a CPU, a ROM, a RAM, and the like, and performs various data processes by executing programs stored in the ROM, and performs overall control in the image capturing system 1 as well as the camera 100. Various set values set by the user to control the operation of the camera 100 are stored in the storage medium in which storage contents are rewritable, such as an EEPROM, included in the camera controller 104.

The operation unit 117 is configured by buttons, switches, a touch panel, etc. that receive an operation by the user, and notifies the camera controller 104 of the input operation by the user. The operation unit 117 includes, for example, a power switch, an AF instruction button, a mode setting dial, a release button, a moving image button, a flicker detection instruction button, and the like. The communication terminal 113 is connected to the communication terminal 206 of the lens unit 200, thereby enabling communication between the camera controller 104 and the lens controller 205. In the following description, unless specifically mentioned, the communication between the camera controller 104 and the lens controller 205 is performed by communication connection via the communication terminals 113 and 206.

The image display unit 114 is specifically a rear monitor or an EVF configured using an LCD panel and displays various kinds of information such as a captured image and an image capturing condition. The memory controller 115 stores image data of a captured image (a still image or a moving image) in the memory 116 and conversely, reads the image data stored in the memory 116 and provides it to the camera controller 104. The memory 116 is, for example, a memory card that is detachable from the camera 100, and mainly stores image data of a captured image (a still image or a moving image).

Next, functional units (a software configuration) of the camera controller 104 will be described. The camera controller 104 includes a digital gain unit 105, an image processor 106, a photometric processor 107, an exposure controller 108, a focus detection processor 109, and a flicker detection processor 110 as the functional units that execute various data processes.

The digital gain unit 105 adds a digital gain to a digital signal transmitted from the analog signal processor 103 and outputs the digital signal to the image processor 106.

The image processor 106 applies image processes, such as a WB process, a pixel interpolation process, a color conversion process, and a compression/decompression process, to the digital signal output from the digital gain unit 105 to generate image data. The generated image data is stored in the memory 116 via the memory controller 115. The image processor 106 performs D/A conversion on the image data transmitted from the memory controller 115 to generate an image signal to be displayed on the image display unit 114.

The photometric processor 107 calculates a luminance value (photometric value) of an object image based on the digital signal output from the digital gain unit 105, and outputs the calculated luminance value to the exposure controller 108.

The exposure controller 108 calculates exposure control values including an aperture value Av, a shutter speed Tv, and a gain amount Sv based on the luminance value transmitted from the photometric processor 107. The aperture value Av is a control value of the diaphragm 202 of the lens unit 200. The shutter speed Tv is a value for controlling the time of incidence of the light beam on the image sensor 102 using an electronic shutter function or a mechanical shutter function. The gain amount Sv represents the magnitude of the gain added by the analog signal processor 103 or the digital gain unit 105.

The focus detection processor 109 detects a phase difference between a pair of images based on the digital signals of the focus detection pixels output from the analog signal processor 103 and performs a focus detection process of the image capturing optical system based on the detected phase difference.

The flicker detection processor 110 detects a frequency of a flicker light source using data of frame images that are digital signals continuously captured and output from the analog signal processor 103.

In the following description, the camera controller 104 is assumed to perform various kinds of control and processes except for the processes executed as the digital gain unit 105, the image processor 106, the photometric processor 107, the exposure controller 108, the focus detection processor 109, and the flicker detection processor 110 described above.

Next, the lens unit 200 will be described. The lens unit 200 is what is called an interchangeable lens that is attachable to and detachable from the camera 100. The lens unit 200 may be integrated with the camera 100 (not detachable). In such a case, the function of the lens controller 205 is generally integrated into the camera controller 104. However, in the present embodiment, the lens controller 205 and the camera controller 104 coexist because it is necessary to switch a controlling role of the diaphragm 202 between the camera controller 104 and the lens controller 205.

The lens system 201 is configured by a plurality of lens groups, such as a zoom lens group, a focus lens group, and an image stabilization lens, and images the incident light from the object field on the image capturing surface of the image sensor 102. The diaphragm 202 controls an incident light amount guided to the image sensor 102 (the light amount received by the image sensor 102) by controlling the aperture diameter. The diaphragm driver 204 drives the diaphragm 202 in accordance with a control signal from the lens controller 205.

The focus driver 203 controls the position of the focus lens group constituting the lens system 201 in a direction of an optical axis of the lens system 201 in accordance with the control signal from the lens controller 205, and thus the focusing operation on the object is performed. The communication terminal 206 is connected to the communication terminal 113 of the camera 100, thereby enabling communication between the lens controller 205 and the camera controller 104. The diaphragm position obtaining unit 207 detects information about the actual position (aperture diameter) of the diaphragm 202, specifically, an effective aperture value (actual F number).

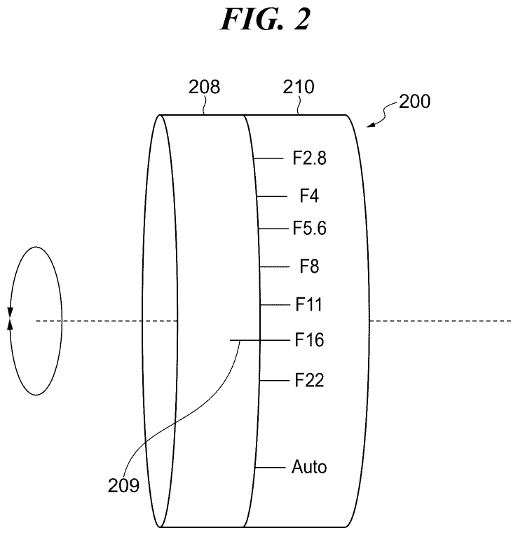

The lens controller 205 controls components of the lens unit 200. For example, the lens controller 205 obtains the effective aperture value of the diaphragm 202 detected by the diaphragm position obtaining unit 207 and transmits the obtained effective aperture value to the camera controller 104. The lens controller 205 switches a drive mode for the diaphragm 202 between a manual diaphragm drive mode (a first mode) and an automatic diaphragm drive mode (a second mode). The manual diaphragm drive mode and the automatic diaphragm drive mode will be described with reference to FIG. 2.

FIG. 2 is an external perspective view illustrating the lens unit 200. The lens unit 200 includes a fixed barrel 210 and a diaphragm drive ring (an aperture value setting member) 208 attached to the fixed cylinder 210 so as to be rotatable in two directions indicated by a double-headed arrow around the optical axis indicated by a broken line. The diaphragm drive ring 208 is provided with an index 209. A plurality of settable aperture values (F values) and “Auto” indicating that aperture value is set by the camera 100 are printed or engraved on the fixed barrel 210.

In a state where the user rotates the diaphragm drive ring 208 to align the index 209 to one of the aperture values printed on the fixed barrel 210 (a state where the diaphragm drive ring 208 is operated into a first range), the drive mode for controlling the diaphragm 202 is set to the manual diaphragm drive mode. On the other hand, in a state where the user rotates the diaphragm drive ring 208 to align the index 209 to the “Auto” printed on the fixed barrel 210 (a state where the diaphragm drive ring 208 is operated into a second range), the drive mode for controlling the diaphragm 202 is set to the automatic diaphragm drive mode.

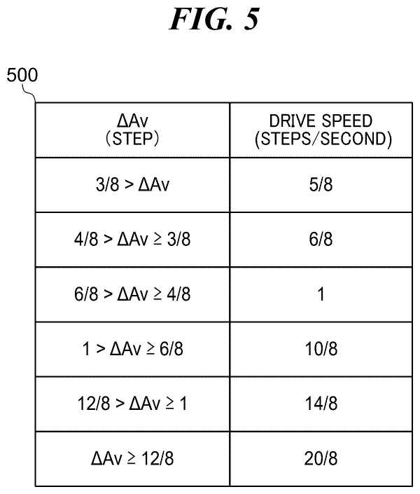

In the manual diaphragm drive mode, the user can set the aperture value to be instructed to the lens controller 205 by rotating the diaphragm drive ring 208 to align the index 209 to a desired one of the aperture values printed on the fixed barrel 210. The lens controller 205 plays a diaphragm controlling role to drive the diaphragm 202 by controlling the diaphragm driver 204 (i.e., controls the aperture diameter) so as to be set to the aperture value set by the user (hereinafter referred to as “set aperture value”) by the rotation operation of the diaphragm drive ring 208. At this time, the lens controller 205 determines a speed for driving the diaphragm 202 based on a deviation amount between the current effective aperture value of the diaphragm 202 and the set aperture value (a first aperture value) so that the drive control of the diaphragm 202 will be performed at a higher speed as the deviation amount is larger. This will be described later with reference to FIG. 5.

When the user rotates the diaphragm drive ring 208 to align the index 209 to the “Auto” printed on the fixed barrel 210 from one of the aperture values, the drive mode of the diaphragm 202 is switched from the manual diaphragm drive mode to the automatic diaphragm drive mode. In the automatic diaphragm drive mode, the camera controller 104 plays the controlling role of the diaphragm 202 and drivingly controls the diaphragm 202 via the lens controller 205. Although details will be described later, in the automatic diaphragm drive mode, the lens controller 205 controls the diaphragm driver 204 so that the aperture diameter of the diaphragm 202 will match a target aperture value transmitted from the camera controller 104.

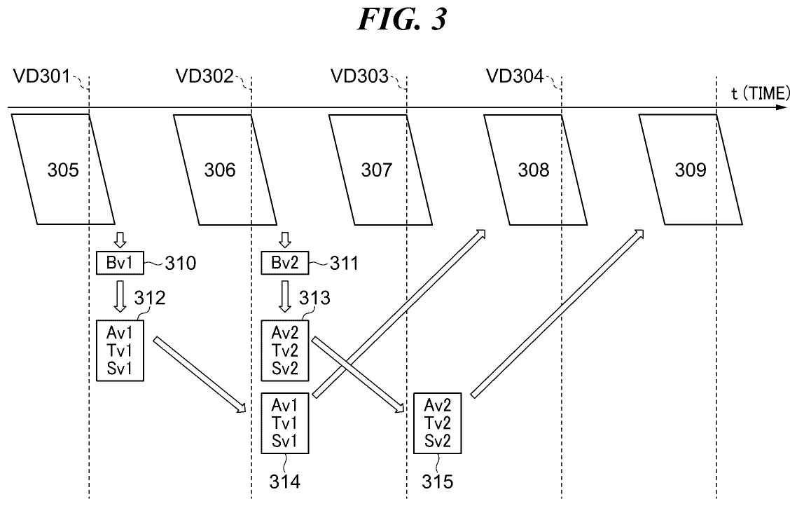

Next, a live view operation of the camera 100 will be described. FIG. 3 is a schematic view illustrating the live view operation of the camera 100.

Frame images 305 to 309, which are constituted by digital signals, shall be generated in this order in accordance with electric charges read from the image sensor 102. First, the photometric processor 107 executes photometric calculations 310 and 311 for calculating luminance values (photometric values Bv) of an object image based on the frame images 305 and 306. Then, the exposure controller 108 performs exposure calculations 312 and 313 for calculating exposure control values based on the photometric values calculated by the photometric calculations 310 and 311 and a program diagram stored in the ROM in advance. As described above, the exposure control values are constituted by the aperture value Av, shutter speed Tv, and gain amount Sv. The exposure controller 108 further performs exposure settings 314 and 315 for transmitting the exposure control values (Av, Tv, and Sv) calculated by the exposure calculations 312 and 313 to the image sensor 102, the analog signal processor 103, and the digital gain unit 105. Thus, the exposure control values (Av, Tv, and Sv) calculated by the exposure calculations 312 and 313 are respectively reflected to the frame images 308 and 309.

The photometric calculation 310 and the exposure calculation 312 for the frame image 305 are performed in a period between vertical synchronization signals VD301 and VD302 output from the timing generator 112. The exposure setting 314 is performed in a period between vertical synchronization signals VD302 and VD303. The exposure control values set in the exposure setting 314 are reflected to the frame image 308 that is image data accumulated in a period between VD303 and VD304.

Similarly, the photometric calculation 311 and the exposure calculation 313 for the frame image 306 are performed in the period between VD302 and VD303, the exposure setting 315 is performed in the period between VD303 and VD304, and the exposure control values set in the exposure setting 315 are reflected to the frame image 309.

In this way, since the exposures of the frame images 308 and 309 generated later are controlled on the basis of the photometric value and the exposure control values calculated from the frame image 305 and 306 generated in advance, it is possible to obtain a frame image with an appropriate exposure amount even if the luminance of the object image changes.

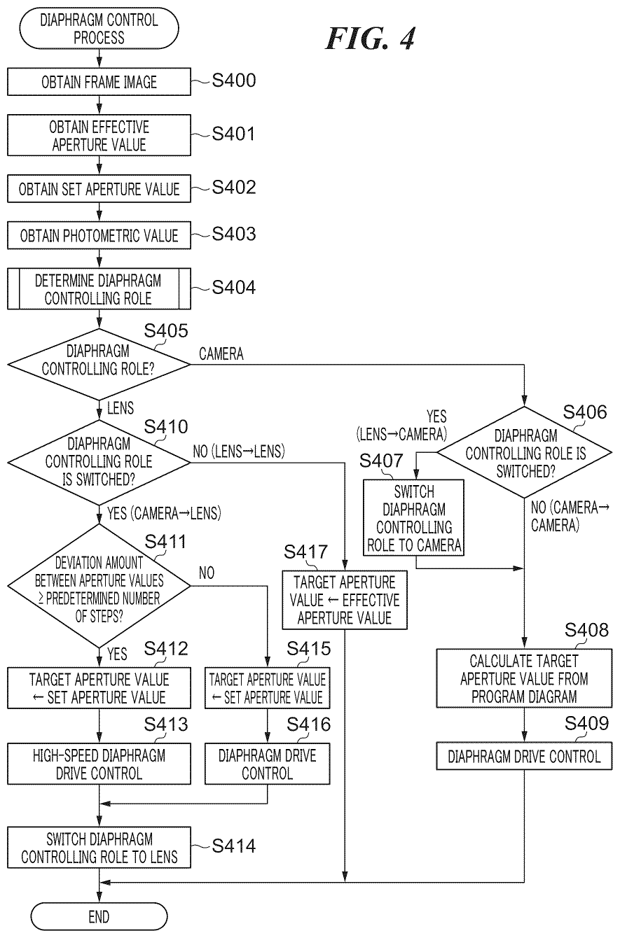

Next, the diaphragm control performed during the live view operation of the camera 100 will be described. FIG. 4 is a flowchart illustrating a diaphragm control process executed during the live view operation of the camera 100. Each process (step) indicated by an S number in this flowchart is achieved by the camera controller 104 executing a predetermined program stored in the ROM and totally controlling the operation of each section of the image capturing system 1.

When detecting that a power switch, which is one element of the operation unit 117, is turned ON, the camera controller 104 activates the image capturing system 1 to start the live view operation, and starts the present process, which is a portion of the exposure calculation and the exposure setting described with reference to FIG. 3. The process according to the flowchart is repeatedly executed after starting the live view operation.

In S400, the camera controller 104 reads the charges accumulated in the image sensor 102 and obtains a frame image.

In S401, the camera controller 104 obtains the effective aperture value from the lens controller 205.

In S402, the camera controller 104 obtains the set aperture value (one of the plurality of aperture values or “Auto”) of the diaphragm drive ring 208 from the lens controller 205.

In S403, the camera controller 104 performs the photometric calculation by the photometric processor 107 and obtains a photometric value as a calculation result.

In S404, the camera controller 104 executes a diaphragm controlling role determination process. Details of the process in S404 will be described later. In the diaphragm controlling role determination process, it is determined whether the camera controller 104 or the lens controller 205 should play the diaphragm controlling role (in other words, whether the diaphragm controlling role needs to be set).

In S405, the camera controller 104 branches the process in accordance with the diaphragm controlling role determined in S404. For example, when the camera controller 104 determines in S404 that the camera controller 104 should play the diaphragm controlling role, the camera controller 104 branches in S405 the process to S406. In FIG. 4, the camera controller 104 and the lens controller 205 are abbreviated as “CAMERA” and “LENS”, respectively.

In S406, the camera controller 104 determines whether the diaphragm controlling role is switched. Specifically, when it is determined in S404 that the camera controller 104 should play the diaphragm controlling role in a state where the lens controller 205 is playing the diaphragm controlling role, it is determined that the diaphragm controlling role is switched in S406. On the other hand, when it is determined in S404 that the camera controller 104 should play the diaphragm controlling role in a state where the camera controller 104 is playing the diaphragm controlling role, it is determined in S406 that the diaphragm controlling role is not switched.

When it is determined that diaphragm controlling role is switched (YES in S406), the camera controller 104 executes a process in S407 and then executes a process in S408. When it is determined that diaphragm controlling role is not switched (NO in S406), the camera controller 104 executes the process in S408 without executing the process in S407.

In S407, the camera controller 104 performs a process to switch the diaphragm controlling role from the lens controller 205 to the camera controller 104. Specifically, the camera controller 104 transmits an instruction (hereinafter, referred to as a “switching instruction”) to the lens controller 205 to switch the diaphragm controlling role from the lens controller 205 to the camera controller 104. When receiving the switching instruction from the camera controller 104, the lens controller 103 transitions to a mode in which the lens controller 103 drives the diaphragm 202 in accordance with the instruction from the camera controller 104. That is, the transition from the manual diaphragm drive mode to the automatic diaphragm drive mode is performed. In the automatic diaphragm drive mode, the camera controller 104 forcibly controls the lens controller 205 so that the effective aperture value of the diaphragm 202 matches the target aperture value instructed from the camera controller 104. When the process in S407 is completed, the camera controller 104 executes the process in S408.

In S408, the camera controller 104 calculates the exposure control values to obtain a live view image (a frame image). Specifically, the exposure controller 108 obtains a target aperture value Av, a shutter speed Tv, and a gain amount Sv based on the photometric value obtained in the latest S403 and the program diagram stored in the ROM in advance, and notifies the camera controller 104 of the target aperture value (a second aperture value) Av. Note that only the setting of the target aperture value that is information related to S409 is described in S408 in FIG. 4.

In S409, the camera controller 104 drivingly controls the diaphragm 202 via the lens controller 205 so as to achieve the target aperture value Av notified in S408 from the exposure controller 108, and thus the process for one routine ends.

When the camera controller 104 determines in S404 that it is necessary to set the diaphragm controlling role to the lens controller 205, the camera controller 104 branches in S405 the process to S410.

In S410, the camera controller 104 determines whether the diaphragm controlling role is switched. When determining that the diaphragm controlling role is switched (YES in S410), the camera controller 104 executes a process in S411. On the other hand, when determining that the diaphragm controlling role is not switched (NO in S410), the camera controller 104 executes a process in S417.

The determination method in S410 is similar to that in S406. When it is determined in S404 that the lens controller 205 should play the diaphragm controlling role in a state where the lens controller 205 is playing the diaphragm controlling role, it is determined that the diaphragm controlling role is not switched in S410. On the other hand, when it is determined in S404 that the lens controller 205 should play the diaphragm controlling role in a state where the camera controller 104 is playing the diaphragm controlling role, it is determined in S410 that the diaphragm controlling role is switched.

In S411, the camera controller 104 determines whether a deviation amount between the effective aperture value and the set aperture value obtained in the latest S401 and S402 is equal to or greater than a predetermined number of steps. When determining that the deviation amount between the aperture values is equal to or larger than the predetermined number of steps (YES in S411), the camera controller 104 executes a process in S412. When determining that the deviation amount between the aperture values is smaller than the predetermined number of steps (NO in S411), the camera controller 1011 executes a process in S415. The predetermined number of steps may be, for example, one step.

In S412, the camera controller 104 calculates exposure control values in obtaining a frame image for the live view. Specifically, the exposure controller 108 sets the set aperture value obtained in the latest S402 to the target aperture value Av. Then, the exposure controller 108 calculates the shutter speed Tv and the gain amount Sv based on the target aperture value Av set, the photometric value obtained in the latest S403, and the program diagram stored in the ROM in advance. The camera controller 104 notifies the lens controller 205 of the target aperture value Av calculated by the exposure controller 108 in this way. Note that only the setting of the target aperture value that is information related to S413 is described in S412 in FIG. 4.

In S413, the camera controller 104 causes the lens controller 205 to perform a high-speed drive control of the diaphragm 202. Specifically, the camera controller 104 drivingly controls the diaphragm 202 via the lens controller 205 so that the diaphragm 202 is set to the target aperture value Av notified to the lens controller 205 in S412. At this time, the drive speed of the diaphragm 202 is desirably a controllable maximum speed, and is set to a speed at least higher than that when the lens controller 205 drives the diaphragm 202 as the diaphragm controlling role in the manual diaphragm drive mode.

Here, a diaphragm drive speed table 500 in the manual diaphragm drive mode is shown in FIG. 5. In S413, the diaphragm 202 is drivingly controlled at a speed higher than 20/8 (steps/second) defined in the aperture drive speed table 500. Note that ΔAv denotes the deviation amount between the aperture values.

In S414, the camera controller 104 sends the switching instruction to the lens controller 205 to switch the diaphragm controlling role from the camera controller 104 to the lens controller 205. Upon receiving the switching instruction from the camera controller 104, the lens controller 205 causes the lens unit 200 to transition to the manual diaphragm drive mode in which the diaphragm is driven by the operation of the diaphragm drive ring 208. Thus, the process for one routine ends.

In the manual diaphragm drive mode, first, when the set aperture value is changed by the user operation of the diaphragm drive ring 208, the lens controller 205 calculates the deviation amount ΔAv between the effective aperture value obtained from the diaphragm position obtaining unit 207 and the set aperture value set with the diaphragm drive ring 208. Then, the lens controller 205 determines the drive speed of the diaphragm 202 by referring to the diaphragm drive speed table 500 and controls the diaphragm driver 204 so that the effective aperture value of the diaphragm 202 matches the set aperture value set with the diaphragm drive ring 208. At this time, the drive speed (steps/second) of the diaphragm 202 is increased as the deviation amount ΔAv between the effective aperture value and the set aperture value is increased, and is decreased as the deviation amount ΔAv is decreased as shown in FIG. 5. For example, when the effective aperture value of the diaphragm 202 is F2 and the set aperture value set in the diaphragm drive ring 208 is F4, the divergence amount ΔAv is two steps, which corresponds to the case of “ΔAv≥12/8” in FIG. 5, and the drive speed of 20/8 (steps/second) is obtained.

When the determination result in S411 is “NO”, the camera controller 104 calculates the exposure control values in obtaining a frame image for the live view in S415. The process in S415 is the same as the process in S412, and thus the description thereof will be omitted. Note that only the setting of the “target aperture value” that is information related to S416 is described in S415 in FIG. 4.

In S416, the camera controller 104 drivingly controls the diaphragm 202 via the lens controller 205 so as to achieve the target aperture value Av, and then executes the process in S414. In S416, the diaphragm 202 is driven at the drive speed corresponding to the deviation amount ΔAv obtained in S411 from the diaphragm drive speed table 500. When the predetermined number of steps serving as a determination criteria in S411 is one step, the drive speed of the diaphragm 202 in S416 is 10/8 (steps/second) or less.

When the determination result in S410 is “NO”, the camera controller 104 calculates the exposure control values in obtaining a live view image (a frame image) in S417. Specifically, the exposure controller 108 calculates the shutter speed Tv and the gain amount Sv based on the effective aperture value obtained in the latest S401, the photometric value obtained in the latest S403, and the program diagram stored in the ROM in advance. Here, since the lens controller 205 plays the diaphragm controlling role and the manual diaphragm drive mode is kept, the process for one routine ends without issuing a drive instruction from the camera controller 104 to the lens controller 205.

As described above, the process of the present flowchart is repeatedly executed after starting the live view operation. That is, when the process for one routine is completed by any one of S409, S414, and S417, the process from S400 is executed again.

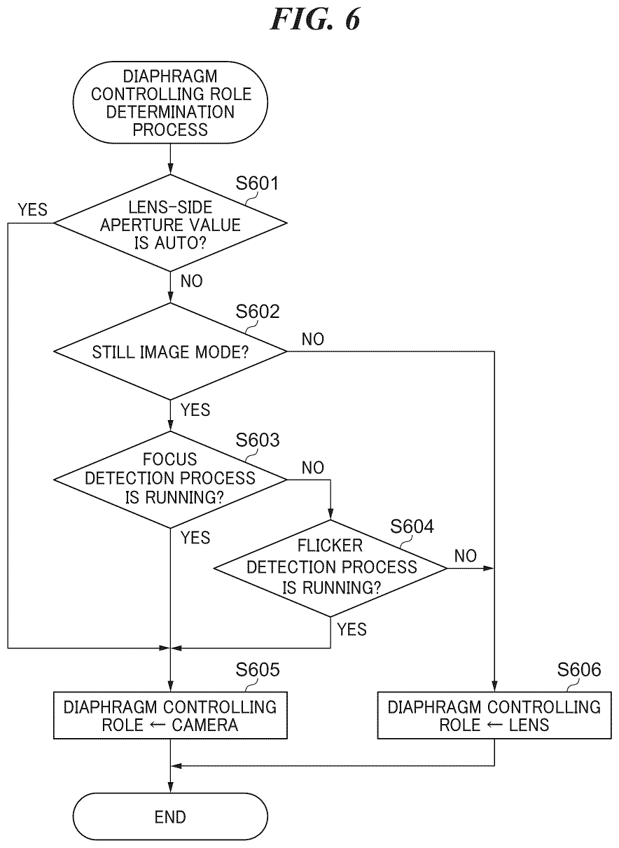

Next, the process of determining the diaphragm controlling role in S404 will be described. FIG. 6 is a flowchart illustrating the diaphragm controlling role determination processing in S404.

In S601, the camera controller 104 determines whether the set aperture value obtained in S402 is “Auto”. When determining that the set aperture value is “Auto” (YES in S601), the camera controller 104 executes a process in S605. When determining that the set aperture value is not “Auto” (NO in S601), the camera controller 104 executes a process in S602.

In S602, the camera controller 104 determines whether an image capturing mode is a still image capturing mode. When determining that the image capturing mode is the still image capturing mode (YES in S602), the camera controller 104 executes a process in S603. When determining that the image capturing mode is not the still image capturing mode (NO in S602), the camera controller 104 executes a process in S606. A moving image capturing mode is assumed as an image capturing mode in the case where the determination result in S602 is “NO”. In the moving image capturing mode, frame images that are continuously captured are continuously recorded and a process in which scenes change is recorded.

In S603, the camera controller 104 determines whether a focus detection process is running. For example, the camera controller 104 determines that the focus detection process is running when an instruction for an AF operation is received due to an operation of an AF instruction button, which is one component of the operation unit 117. When it is determined that the focus detection process is running (YES in S603), the camera controller 104 executes the process in S605. When it is determined that the focus detection process is not running (NO in S603), the camera controller 104 executes a process in S604.

In S604, the camera controller 104 determines whether a flicker detection process (a flicker light source detection process) is running. For example, the camera controller 104 determines that the flicker detection process is running when a flicker detection instruction is received due to an operation of the flicker detection instruction button, which is one component of the operation unit 117. When it is determined that the flicker detection process is running (YES in S604), the camera controller 104 executes the process in S605. When it is determined that the flicker detection process is not running (NO in S604), the camera controller 104 executes the process in S606.

The camera controller 104 determines that the camera controller 104 should play the diaphragm controlling role in S605 and ends this process.

The camera controller 104 determines that the lens controller 205 should play the diaphragm controlling role in S606 and ends this process.

Note that, when the determination result in S602 is “NO”, it is assumed that the image capturing mode is the moving image capturing mode as described above. In the moving image capturing mode, high response to the operation of changing the aperture value setting from the user via the diaphragm drive ring 208 is desired. Therefore, it is desirable that the lens controller 205 plays the controlling role of the diaphragm 202 in the moving image capturing mode. In addition, since a detection accuracy of the focus detection process by the image plane phase difference AF generally decreases when the diaphragm is on a small aperture side, it is desirable to control the diaphragm 202 by the camera controller 104 so as to control the diaphragm 202 suitable for the focus detection process. Therefore, when the determination result in S603 is “YES”, it is desirable that the camera controller 104 plays the diaphragm controlling role. In the flicker detection process, an image with appropriate brightness cannot be obtained depending on the luminance of the object image, and the detection accuracy is reduced. Therefore, it is desirable to control the diaphragm 202 by the camera controller 104 so as to control the diaphragm suitable for the flicker detection process. In this way, when the determination result in S604 is “YES”, it is desirable that the camera controller 104 plays the diaphragm controlling role. On the other hand, even in the still image capturing mode, when the determination results in S603 and S604 are both “NO”, a stationary image capturing standby state in which no special process is executed in the camera 100 is assumed. In this case, it is desirable that the lens controller 205 plays the controlling role of the diaphragm 202 in the present embodiment from a viewpoint of enhancing the response to the operation of changing the aperture value setting by the user via the diaphragm drive ring 208.

As described above, the controlling role of the diaphragm 202 is appropriately switched in the image capturing system 1 during the live view operation in accordance with the setting of the diaphragm drive ring 208 and the operation of the image capturing system 1. Usefulness of performing the process of the flowchart in FIG. 4 at that time will be described below in comparison with a reference example (a comparative example).

First, the reference example against the present disclosure will be described. For example, in the moving image capturing mode in which a process of scene transition is recorded by continuously recording frame images continuously captured, it is desirable that the diaphragm drive control is immediately executed in response to the setting change of the aperture value by the user. On the other hand, in the still image capturing mode in which an image is recorded singularly, it is desirable that the drive control of the diaphragm 202 is executed in response to a diaphragm driving instruction on the camera 100 side. In this way, it is desirable that the camera controller 104 plays the diaphragm controlling role in the still image capturing mode and the lens controller 205 plays the diaphragm controlling role in the moving image capturing mode.

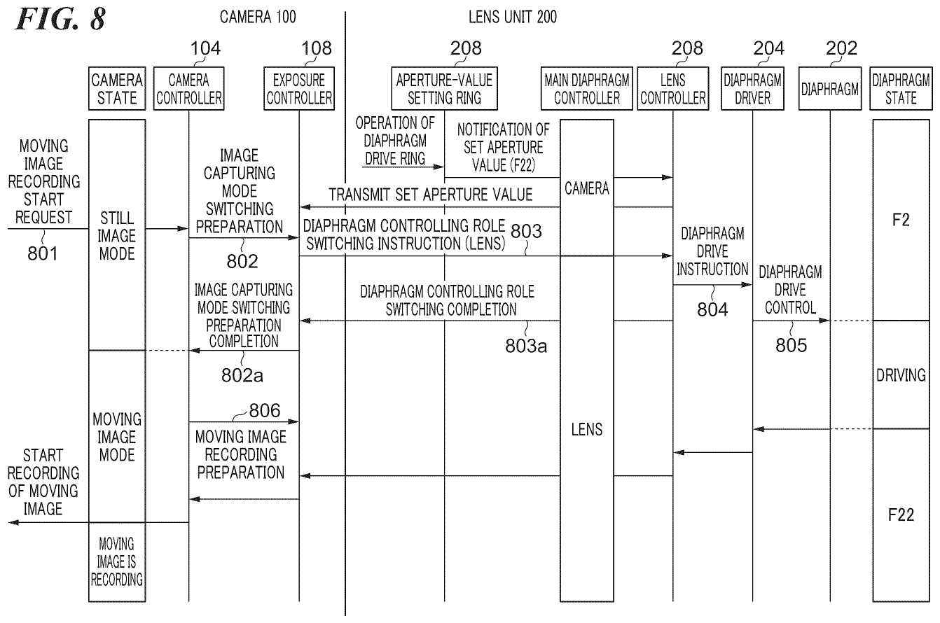

Here, the user may start recording a moving image by pressing a moving image button in the state where the diaphragm controlling role is set to the camera controller 104. In this case, the diaphragm controlling role is switched from the camera controller 104 to the lens controller 205 and the moving image recording is started. However, at this time, there is a problem that an image capturing time lag from the press of the moving image button to the start of the moving image recording becomes long. This problem will be described using the reference example with reference to FIG. 8.

FIG. 8 is a timing chart illustrating a process switching the diaphragm controlling role from the camera controller 104 to the lens controller 205 according to the reference example.

When the user operates the operation unit 117 and a moving image recording start request 801 is generated, the camera controller 104 notifies the exposure controller 108 of an image capturing mode switching preparation 802. As described above, when the image capturing mode is switched from the still image capturing mode to the moving image capturing mode, it is necessary to switch the diaphragm controlling role from the camera controller 104 to the lens controller 205. Therefore, the exposure controller 108 notifies the lens controller 205 of a diaphragm controlling role switching instruction 803.

In response to the switching instruction 803, the lens controller 205 notifies the exposure controller 108 of a diaphragm controlling role switching completion 803a indicating that the diaphragm controlling role is switched from the camera controller 104 to the lens controller 205. Upon receiving the diaphragm controlling role switching completion 803a, the exposure controller 108 notifies the camera controller 104 of image capturing mode switching preparation completion 802a, and the camera controller 104 switches the image capturing mode to the moving image capturing mode.

In response to the switching of the diaphragm controlling role to the lens controller 205, the lens controller 205 notifies the diaphragm driver 204 of a diaphragm drive instruction 804 so that the set aperture value (F22 in FIG. 8) set with the diaphragm drive ring 208 is achieved. The diaphragm driver 204 receives the diaphragm drive instruction 804 and drives the diaphragm 202 in accordance with diaphragm drive control 805.

For example, the diaphragm 202 shall be controlled to be the aperture value (F2 in FIG. 8) determined by the camera controller 104 in order to suppress deterioration of a capability of a specific camera function in a state where the image capturing mode is the still image capturing mode. In this case, the drive control is executed by the diaphragm drive control 805 so that the aperture value changes from F2 to F22. At this time, since it is desirable to smoothly drive the diaphragm 202 in consideration of image quality in the live view, it is necessary to drive the diaphragm 202 at a low speed in the moving image capturing mode in which the lens controller 205 plays the diaphragm controlling role.

Subsequently, the camera controller 104 notifies the exposure controller 108 of a moving image recording preparation 806. The moving image needs to be recorded in the aperture value desired by the user (set by the user). Therefore, the exposure controller 108 completes the process of the moving image recording preparation 806 and notifies the camera controller 104 when the driving of the diaphragm 202 to the set aperture value (F22 in FIG. 8) set with the diaphragm drive ring 208 is completed. Upon receiving the completion notification of the moving image recording preparation 806, the camera controller 104 starts the moving image recording.

In such control, it takes time until the drive control of the diaphragm 202 being driven by the diaphragm drive control 805 is completed. Therefore, it takes time to complete the process of the moving image recording preparation 806, and the image capturing time lag from the instruction to start the moving image recording to the actual start of the moving image recording becomes long.

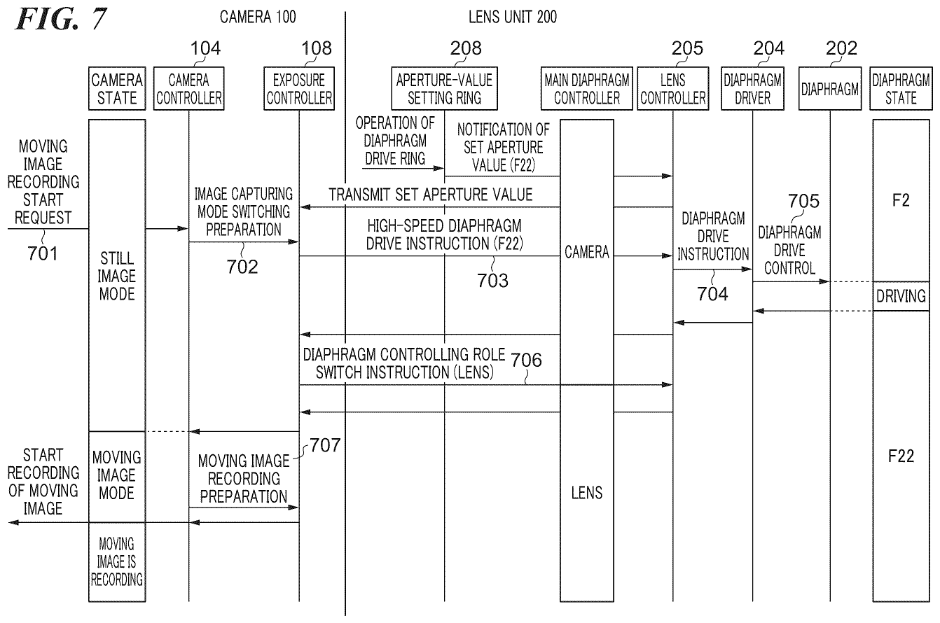

A sequence according to the embodiment that solves such a problem will be described with reference to FIG. 7. FIG. 7 is a timing chart illustrating a process switching the diaphragm controlling role from the camera controller 104 to the lens controller 205 according to the embodiment. At this time, the process proceeds along a route passing through S404, S405, S410, and S411 of the flowchart in FIG. 4.

When a moving image recording start request 701 is generated by the user operation, the camera controller 104 notifies the exposure controller 108 of an image capturing mode switching preparation 702. At this time, the exposure controller 108 notifies the lens controller 205 of a high-speed diaphragm drive instruction 703 before switching the diaphragm controlling role in order to quickly achieve the set aperture value (F22 in FIG. 7) set with the diaphragm drive ring 208. When receiving the high-speed diaphragm drive instruction 703, the lens controller 205 notifies the diaphragm driver 204 of a diaphragm drive instruction 704. When receiving the diaphragm drive instruction 704, the diaphragm driver 204 drives the diaphragm 202 at the high speed in accordance with diaphragm drive control 705. At this time, the drive speed of the diaphragm 202 is desirably a controllable maximum speed, and thus the diaphragm 202 can be quickly achieve the target aperture value (F22 in FIG. 7).

When the drive control to set the diaphragm 202 to the set aperture value (F22 in FIG. 7) set with the diaphragm drive ring 208 is completed, the exposure controller 108 notifies the lens controller 205 of a diaphragm controlling role switch instruction 706 in order to switch the diaphragm controlling role to the lens controller 205. Then, the exposure controller 108 notifies the camera controller 104 that the process of the image capturing mode switching preparation 702 is completed when the diaphragm controlling role is switched to the lens controller 205. Upon receiving the completion notification, the camera controller 104 switches the image capturing mode from still image capturing mode to the moving image capturing mode.

Subsequently, the camera controller 104 notifies the exposure controller 108 of moving image recording preparation 707. At this time, the diaphragm controlling role has already been switched to the lens controller 205. The diaphragm 202 has also been driven to the set aperture value (F22 in FIG. 7) set with the diaphragm drive ring 208. That is, the preparation for recording a moving image has been completed. Therefore, the exposure controller 108 immediately notifies the camera controller 104 of the completion of the moving image recording preparation 707, and the camera controller 104 starts the moving image recording when receiving the completion notification.

As described above, when the image capturing mode is switched from the still image capturing mode to the moving image capturing mode, the diaphragm 202 is driven at the high speed so that the diaphragm 202 achieves the set aperture value set with the diaphragm drive ring 208, and then diaphragm controlling role is switched from the camera controller 104 to the lens controller 205 in the present embodiment. This can shorten the time required for preparation for starting the moving image recording as compared with the reference example in FIG. 8. That is, when the instruction to start the moving image recording is issued in accordance with the user operation in the still image capturing mode, the image capturing time lag until the moving image recording is actually started can be shortened.

In the above embodiment, it is determined that the lens controller 205 should play the diaphragm controlling role when the focus detection or the flicker detection is not performed in the still image capturing mode. In contrast, it is desirable that the camera controller 104 plays the controlling role of the diaphragm 202 in the still image capturing mode for a user who hardly captures a moving image and a user who usually sets the aperture value to Auto when capturing a still image. Therefore, for example, the image capturing system 1 may be configured such that the camera controller 104 plays the controlling role of the diaphragm 202 in the still image capturing mode regardless of the operation state of the image capturing system 1 by a user operation from a menu setting of the camera 100.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-068158, filed Apr. 19, 2024, which is hereby incorporated by reference herein in its entirety.

What is claimed is:

1. An image capturing system comprising:
a lens apparatus comprising
a diaphragm;
a diaphragm driver configured to drive the diaphragm;
an aperture value setting member configured to set a first aperture value in accordance with a user operation; and
a first controller configured to control the diaphragm driver; and
an image capturing apparatus comprising:
a second controller configured to:
set a second aperture value based on a photometric value;
switch a diaphragm controlling role to the first controller from the second controller after controlling the diaphragm driver so as to drive the diaphragm to the first aperture value via the first controller, when an image capturing mode is switched to a first mode in which the first controller controls the diaphragm driver so as to drive the diaphragm to the first aperture value from a second mode in which the second controller controls the diaphragm driver via the first controller so as to drive the diaphragm to the second aperture value.

2. The image capturing system according to claim 1, wherein the lens apparatus includes a detection unit configured to detect an effective aperture value of the diaphragm, and
wherein the second controller controls the diaphragm driver to drive the diaphragm at a controllable maximum drive speed in a case where a deviation amount between the effective aperture value and the first aperture value is equal to or more than a predetermined number of steps in switching from the second mode to the first mode.

3. The image capturing system according to claim 2, wherein the lens apparatus further comprises a memory configured to store a table defining a drive speed of the diaphragm with respect to the deviation amount, and
wherein the second controller controls the diaphragm driver to drive the diaphragm at a drive speed defined for the deviation amount in the table in a case where the deviation amount is less than the predetermined number of steps in switching from the second mode to the first mode.

4. The image capturing system according to claim 3, wherein the first controller controls the diaphragm driver to drive the diaphragm at a drive speed defined for the deviation amount in the table in the first mode.

5. The image capturing system according to claim 1, wherein the second controller determines the first controller as the diaphragm controlling role in a moving image capturing mode and determines the second controller as the diaphragm controlling role in a still image capturing mode.

6. The image capturing system according to claim 1, wherein the second controller determines the first controller as the diaphragm controlling role in a moving image capturing mode or when a focus detection process and a flicker detection process are not running in a still image capturing mode, and
wherein the second controller determines the second controller as the diaphragm controlling role when the focus detection process or the flicker detection process is running in the still image capturing mode.

7. The image capturing system according to claim 1, wherein the aperture value setting member is switchable between a first range in which the diaphragm controlling role is set to the first controller and the first aperture value is set for the diaphragm and a second range in which the diaphragm controlling role is set to the second controller.

8. A control method for an image capturing system that includes a lens apparatus providing a diaphragm, a diaphragm driver driving the diaphragm, and a first controller, and an image capturing apparatus providing a second controller, the control method comprising:
detecting a state of the image capturing system during a live view operation;
determining, in accordance with the state detected, whether a mode is set to a first mode in which the first controller controls the diaphragm driver so as to drive the diaphragm to a first aperture value set in accordance with a user operation or to a second mode in which the second controller controls the diaphragm driver via the first controller so as to drive the diaphragm to a second aperture value set based on the photometric value; and
switching, when the mode is switched from the second mode to the first mode based on the determining, the diaphragm controlling role from the second controller to the first controller after the second controller controls the diaphragm driver via the first controller so as to drive the diaphragm to the first aperture value.

9. A non-transitory computer-readable storage medium storing a control program causing a computer to execute a control method for an image capturing system that includes a lens apparatus providing a diaphragm, a diaphragm driver driving the diaphragm, and a first controller, and an image capturing apparatus providing a second controller, the control method comprising:
detecting a state of the image capturing system during a live view operation;
determining, in accordance with the state detected, whether a mode is set to a first mode in which the first controller controls the diaphragm driver so as to drive the diaphragm to a first aperture value set in accordance with a user operation or to a second mode in which the second controller controls the diaphragm driver via the first controller so as to drive the diaphragm to a second aperture value set based on the photometric value; and
switching, when the mode is switched from the second mode to the first mode based on the determining, a diaphragm controlling role from the second controller to the first controller after the second controller controls the diaphragm driver via the first controller so as to drive the diaphragm to the first aperture value.

10. An image capturing system comprising:
a first controller; and
a second controller configured to:
determining, in accordance with a state of the image capturing system, whether a mode is set to a first mode in which the first controller controls the diaphragm driver so as to drive the diaphragm to a first aperture value set in accordance with a user operation or to a second mode in which the second controller controls the diaphragm driver via the first controller so as to drive the diaphragm to a second aperture value set based on a photometric value; and
switching, when the mode is switched from the second mode to the first mode based on the determining, a diaphragm controlling role from the second controller to the first controller after the second controller controls the diaphragm driver via the first controller so as to drive the diaphragm to the first aperture value.
